(19) United States
(12) Patent Application Publication
(10) Pub. No.: US 2003/0187533 A1
(43) Pub. Date: Oct. 2, 2003

(54) Process managing apparatus for managing production process including production fluctuation process

(75) Inventor: Yoshimasa Ichikawa, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/267,752

(22) Filed: Oct. 10, 2002

(30) Foreign Application Priority Data
Apr. 1, 2002 (JP) 2002-098883 (P)

(51) Int. Cl. G06F 19/00

(52) U.S. Cl. 700/106; 700/99

(57) ABSTRACT

A process managing apparatus includes a fixed disk for storing a production-fluctuation process and a planned proportion of conforming items in a production process, a detection unit for detecting a process under progress and amount of work-in-progress items for each lot, and a CPU for calculating the amount of conforming items for each lot, based on the feed amount for each lot and another proportion different from the planned proportion of conforming items for a lot to be subjected to the production-fluctuation process, and based on the feed amount for each lot and the planned proportion of conforming items for a lot having been subjected to the production-fluctuation process, and then calculating an expected amount of conforming items by summing these amount of conforming items for each lot.

### BACKGROUND OF THE INVENTION

1. Field of the Invention

The present invention relates to an apparatus for managing processes of manufacturing articles, and more specifically, to an apparatus for managing the amount of work-in-progress items to be fed into a process in a semiconductor manufacturing process and the like that is constituted with a plurality of processes including factors such as yield fluctuation.

2. Description of the Background Art

Manufacturing of a semiconductor involves several processes such as designing, mask manufacturing, wafer manufacturing, wafer processing, assembling, inspecting and the like. The wafer processing is further constituted with a number of processes such as thin film depositing, oxidizing, doping, annealing, resist processing, exposing, etching, cleaning and the like.

For semiconductors manufactured through these numerous processes, the amount of work-in-progress items to be fed into a process (hereinafter “feed amount”) is calculated such that the amount of conforming items with all the processes finished exceeds the ordered amount, taking into account of production fluctuation (expressed as the proportion of defective items, the proportion of conforming items, yield and the like, for example) calculated in advance based on empirical values or the like for each process or product. Thus calculated feed amount of the work-in-progress items are divided into a plurality of lots for process management and then fed into processes.

Since the proportion of defective items as the product fluctuation is estimated before work-in-progress items are fed into the process, the amount of defective items actually generated in a lot will not become apparent until the lot is finished with the process associated with production fluctuation (hereinafter “a production-fluctuation process”). As such, if the proportion of actual conforming items resulted from the product fluctuation process exceeds the proportion of conforming items estimated based on an empirical value or the like for the lot, then it will results in overproduction, and otherwise it will results in underproduction. A stable production can not be realized if the production process is scheduled depending on such results.

### SUMMARY OF THE INVENTION

It is an object of the present invention to provide a process managing apparatus for realizing a stable operation of a production process including a process associated with production fluctuation.

It is another object of the present invention to provide a process managing apparatus in which precise amount of conforming items in a process associated with production fluctuation can be recognized for realizing a stable operation of a production process.

It is a further object of the present invention to provide a process managing apparatus for realizing a stable operation of a production process determining feed amount so that conforming items can be obtained in the amount that satisfies a production plan for a process associated with production fluctuation.

A process managing apparatus according to the present invention includes: storage unit prestoring a proportion of the amount of conforming items having been subjected to the production-fluctuation process to the feed amount of work-in-progress items into the production-fluctuation process; detecting unit detecting feed amount for each lot in the production process; calculating circuit calculating an expected amount of conforming items, the calculating circuit calculating the amount of conforming items for each lot, based on the feed amount for each lot and another proportion for a lot to be subjected to the production-fluctuation process, and based on the feed amount and the proportion for a lot having been subjected to the production-fluctuation process; and additional feed amount calculating circuit calculating amount to be fed additionally into the production process based on the calculated expected amount of conforming items.

The process managing apparatus is used for managing a production process including a plurality of processes which includes at least one production-fluctuation process. Work-in-progress items belonging to one product number are divided into a plurality of lots and fed into the production process. The process managing apparatus stores the proportion of conforming items for the production-fluctuation process, and detects feed amount for each lot in each process. The calculating circuit calculates the amount of conforming items, using a proportion higher than the stored proportion of conforming items or a proportion of 100% for a lot to be subjected to the production-fluctuation process, and using the stored proportion for a lot having been subjected to the production-fluctuation process, then by summing thus calculated amount of conforming items, calculates expected amount of conforming items. The additional feed amount calculating circuit calculates the amount to be fed additionally into the production process based on the difference between the expected amount of conforming items and the ordered amount. Thus, as the extent of production fluctuation is not known for a lot before being subjected to a production-fluctuation process, a relatively high proportion of conforming items which is different from the predetermined proportion of conforming items is used, so that the amount of the conforming items is calculated to be relatively large, in order to derive relatively small additional feed amount. As a result, the process managing apparatus realizing a stable operation of production processes without incurring overproduction can be provided.

More preferably, the process managing apparatus further includes output unit outputting an instruction to the production process to additionally feed work-in-progress items in the amount calculated by the additional feed amount calculating circuit.

The output unit of the process managing apparatus enables provision of the instruction of additional feeding, thus the automated feed management is realized to obtain a prescribed amount of conforming items.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows the entire configuration of a process managing system according to an embodiment of the present invention;

FIG. 2 is an external view of a computer system realizing a server shown in FIG. 1;

FIG. 3 is a control block diagram of the computer system shown in FIG. 2;

FIG. 4 is a table of production-fluctuation-process data stored in a fixed disk of the process managing computer;

FIG. 5 is a table of order data stored in the fixed disk of the process managing computer;

FIGS. 6A and 6B are flow charts indicating control architecture of a program executed on the process managing computer according to an embodiment of the present invention; and

FIGS. 7 and 8 are tables of process management data stored in the fixed disk of the process managing computer.

### DESCRIPTION OF THE PREFERRED EMBODIMENTS

Referring to the drawings, embodiments of the present invention will be described. In the following description and the drawings, similar reference numbers identify similar elements. Names and functions thereof are also similar, and thus detailed description thereof are not repeated.

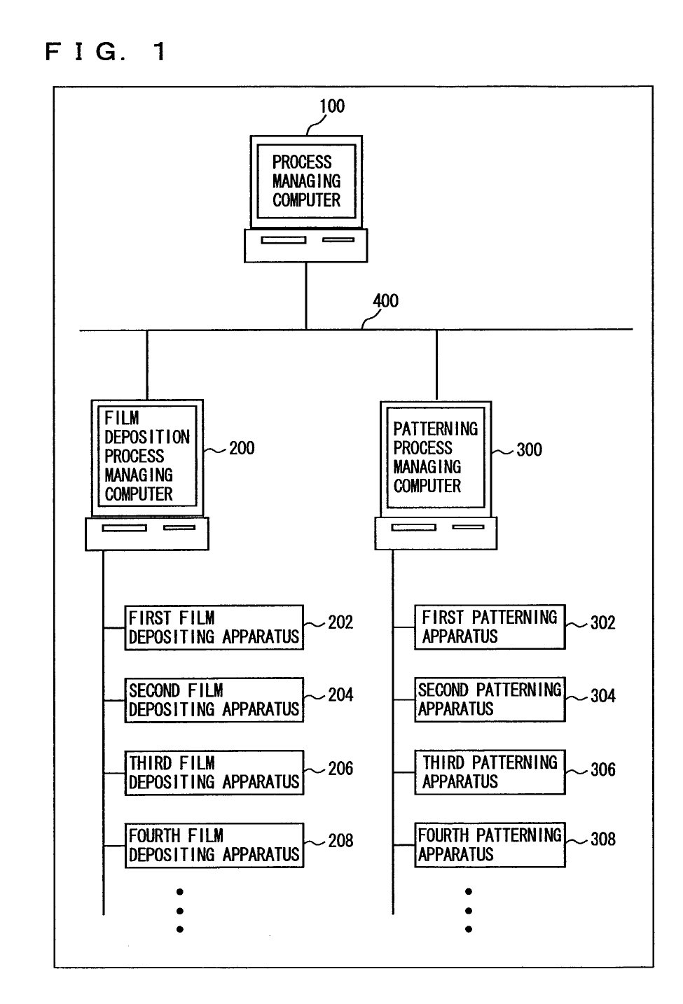

Referring to FIG. 1, a process managing system according to the present embodiment is applied to a semiconductor manufacturing process. The system configuration will be described using film deposition process and patterning process as examples, as part of the manufacturing process. The process managing system includes a process managing computer 100, a film deposition process managing computer 200, a patterning process managing computer 300, and a network 400 connecting these computers for data communication. It should be noted that the system configuration shown in FIG. 1 is only an example and it is not limiting the application of the process managing system of the present invention. Other processes or computers may also be included.

The process managing computer 100 stores production-fluctuation processes and planned proportion of conforming items for each product number of semiconductors. The process managing computer 100 stores product numbers and ordered amount for each order number. The process managing computer 100 receives progression management data indicating the number of work-in-progress items in each lot in each process from the film deposition process managing computer 200 and the patterning process managing computer 300.

The film deposition process managing computer 200 is connected to a plurality of film depositing apparatus 202, 204, 206, and 208 for receiving progression management data indicating the number of work-in-progress items in each lot in each apparatus. The patterning process managing computer 300 is connected to a plurality of patterning apparatus 302, 304, 306, and 308 for receiving progression management data indicating the amount of work-in-progress items in each lot in each apparatus.

The process managing computer calculates the amount of conforming items for each lot, depending on whether the lot has been subjected to the production-fluctuation process or not, then sums thus calculated amount of conforming items of a plurality of lots belonging to one product number to derive the expected amount of conforming items. Here, in order to obtain this expected number of conforming items, 100% of the proportion of conforming items is applied for a lot to be subjected to a production-fluctuation process, and a predetermined proportion of conforming items is applied for a lot having been subjected to a production-fluctuation process. The process managing computer 100 realizes a process managing function, determining the amount to be fed additionally into a process and outputting a feed instruction.

The process managing function of the process managing computer 100 of the process managing system according to the present embodiment is realized by executing a prescribed program by a CPU (Central Processing Unit) in the computer.

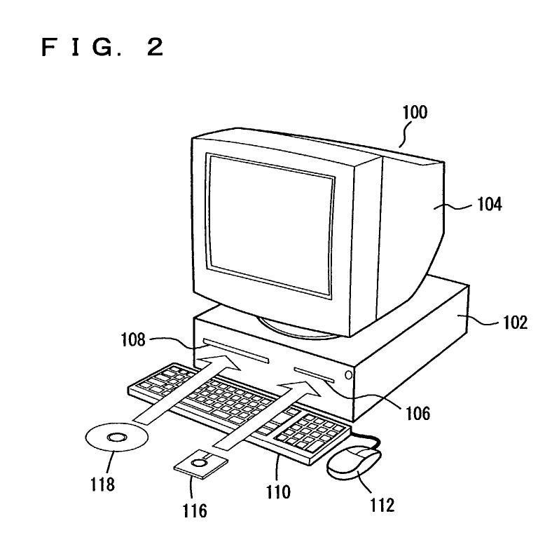

FIG. 2 illustrates an external view of a computer system, which is one example of the process managing computer 100 realizing the process managing function. Referring to FIG. 2, the computer system includes a computer 102 having an FD (Flexible Disk) drive 106 and a CD-ROM (Compact Disc-Read Only Memory) drive 108, a monitor 104, a keyboard 110 and a mouse 112.

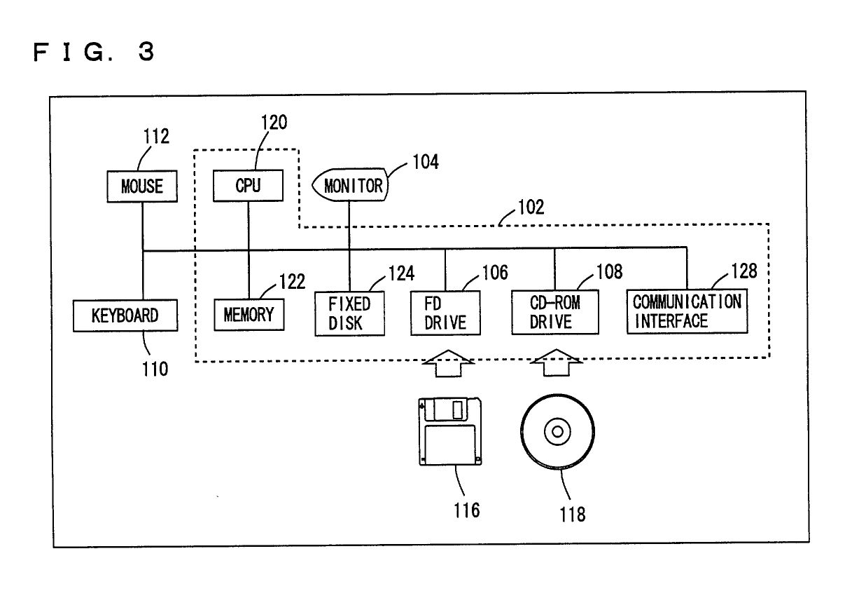

FIG. 3 illustrates the configuration of the computer system in block diagram. As shown in FIG. 3, the computer 102 includes, additionally to the above mentioned FD drive 106 and CD-ROM drive 108, a CPU (Central Processing Unit) 120, a memory 122, a fixed disk 124, and a communication interface 128 for communicating with other computers, all mutually connected with each other through a bus. An FD 116 is placed to the FD driver 106. A CD-ROM 118 is placed to the CD-ROM drive 108. A prescribed program corresponding to software is stored in these FD 116 and CD-ROM 118.

As described above, the process managing computer 100 with process management function is realized by computer hardware and software executed by the CPU 120. Generally, such software is distributed being stored as a program in a record medium such as the FD 116 or the CD-ROM 118, and is read from the record medium by the FD driver 106 or the CD-ROM drive 108 to be temporally stored in the fixed disk 124. Then it is read from the fixed disk 124 to the memory 122 to be executed by the CPU 120.

The computer hardware itself is in common use. The computer includes a control circuit including a CPU, a storage circuit, an input circuit, an output circuit and OS (Operating System), with an environment for executing programs. The program of the present invention allows such computer to function as a process managing apparatus. As such, the most essential part of the present invention is a program recorded in record media such as a FD, a CD-ROM, a memory card, fixed disk and the like.

Since the operation of the computer itself described with reference to FIGS. 2 and 3 is known, detailed description thereof is not repeated.

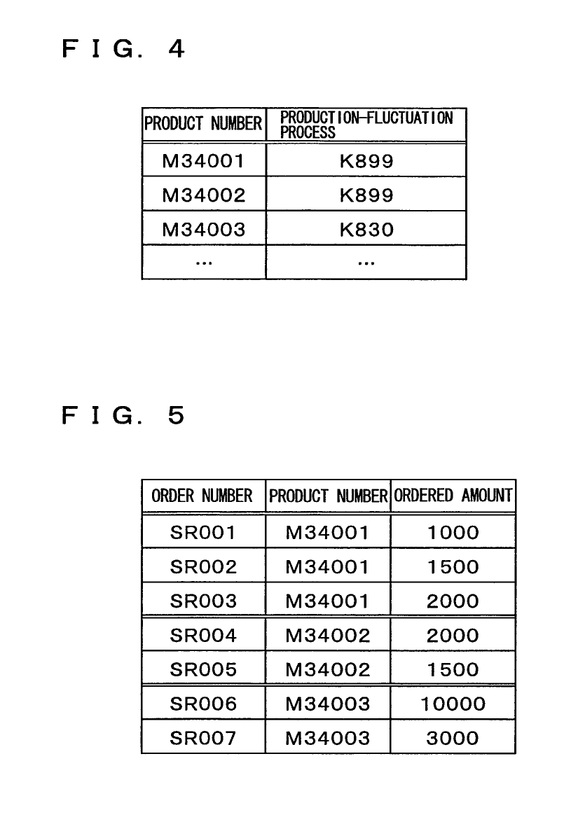

Referring to FIG. 4, data of production-fluctuation process (hereinafter “production-fluctuation-process data”) stored in the fixed disk 124 of the process managing computer 100 according to the present embodiment will be described. As shown in FIG. 4, the production-fluctuation-process data store, for each product number, a production-fluctuation process in which yield, the proportion of conforming items, the proportion of defective items or the like fluctuates. For example, for a product number “M34001”, “K899” is stored as a production-fluctuation process.

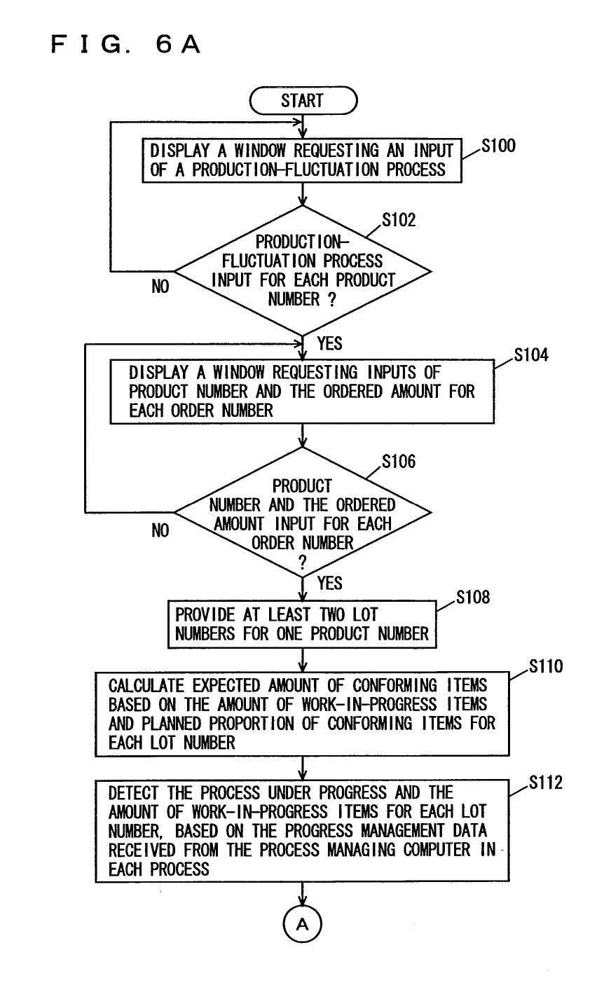

Referring to FIG. 5, order data stored in the fixed disk 124 of the process managing computer 100 according to the present embodiment will be described. As shown in FIG. 5, the order data store, for each order number, corresponding product number and the ordered amount. For example, the order numbers “SR001”, “SR002”, and “SR003” are stored for the same product with a product number “M34001”, and the respective ordered amount are stored as 1,000, 1,500, and 2,000.

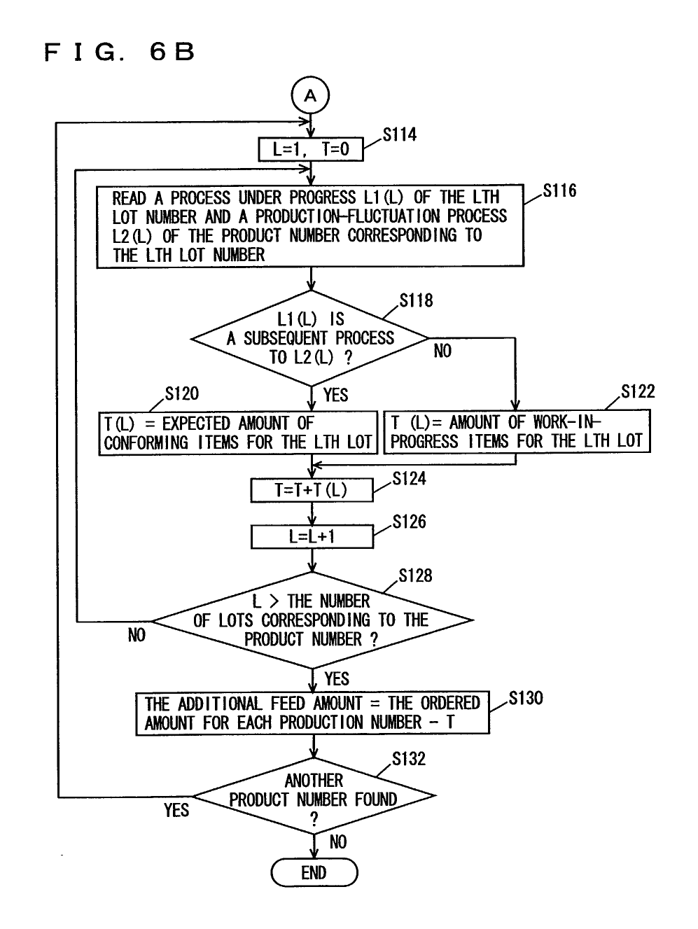

Referring to FIGS. 6A and 6B, a control structure of the program executed by the process managing computer 100 according to the present embodiment will be described.

At step 100 (hereinafter “step” is denoted by “S”), CPU 120 of the process managing computer 100 displays on the monitor 104 a window requesting an input of a production-fluctuation process. At S102, the CPU 120 determines if the production-fluctuation process is input for each product number. If the production-fluctuation process is input for each product number (YES at S102), then the process goes to S104. Otherwise (NO at S102), the process goes back to S100.

At S104, the CPU 120 displays on the monitor 104 a window requesting inputs of product number and the ordered amount for each order number. At S106, the CPU 120 determines if the product number and the ordered amount are input for each order number. If the product number and the ordered amount are input for each order number (YES at S106), the process goes to S108. Otherwise (NO at S102), the process goes back to S104.

At S 108, the CPU 120 provides at least two lot numbers for one product number. At S110, the CPU 120 calculates expected amount of conforming items based on the amount of work-in-progress items and planned proportion of conforming items for each lot number. The planned proportion of conforming items is pre-stored in the fixed disk 124 for each lot number. At S112, the CPU 120 detects the process under progress and the amount of work-in-progress items for each lot number, based on the progress management data received from the process managing computer in each process, and then stores them in the fixed disk 124.

At S 114, the CPU 120 initializes variables Land T(L=1, T=0). At S116, the CPU 120 reads a process under progress L1 (L) of the Lth lot number and a production-fluctuation process L2 (L) of the product number corresponding to the Lth lot number. At S118, the CPU 120 determines if L1 (L) is a subsequent process to L2 (L). If L1 (L) is a subsequent process to L2 (L) (YES at S118), then the process goes to S120. Otherwise (NO at S118), the process goes to S122.

At S120, the CPU 120 assigns, to T (L), the expected amount of conforming items for the Lth lot. At S122, the CPU 120 assigns, to T (L), the amount of work-in-progress items for the Lth lot. After the steps S120 and S122, the process goes to S124.

At S124, the CPU 120 calculates T=T+T (L). At S126, the CPU 120 adds 1 to variable. At S128, the CPU 120 determines if variable L is greater than the number of lots corresponding to the product number. If variable L is greater than the number of lots corresponding to the product number (YES at S128), then the process goes to S130. Otherwise (NO at S128), the process goes back to S116.

At S130, the CPU 120 calculates the additional feed amount as follows: the additional feed amount=the ordered amount for each production number−T. At S132, the CPU 120 determines if another product numbers is found. If another product number is found (YES at S132), then the process goes back to S114. Otherwise (NO at S132), the process ends. After the process of S132, based on the additional feed amount calculated at S130, the CPU 120 may output a feed instruction to the production process.

The operation of the process managing computer according to the present embodiment, based on the structure and the flow charts described above, will be described.

On the monitor of the process managing computer 100, a window requesting an input of a production-fluctuation process is displayed (S100), and following the input of the production-fluctuation process for each product number by a process manager (YES at S102), production-fluctuation-process data (FIG. 4) are generated, which are in turn stored in the fixed disk 120.

On the monitor 104, for each order number, a window requesting inputs of a product number and ordered amount is displayed (S104), and following the inputs of the product number and ordered amount for each order number by a process manager (YES at S102), order data (FIG. 5) are generated, which is in turn stored in the fixed disk 120.

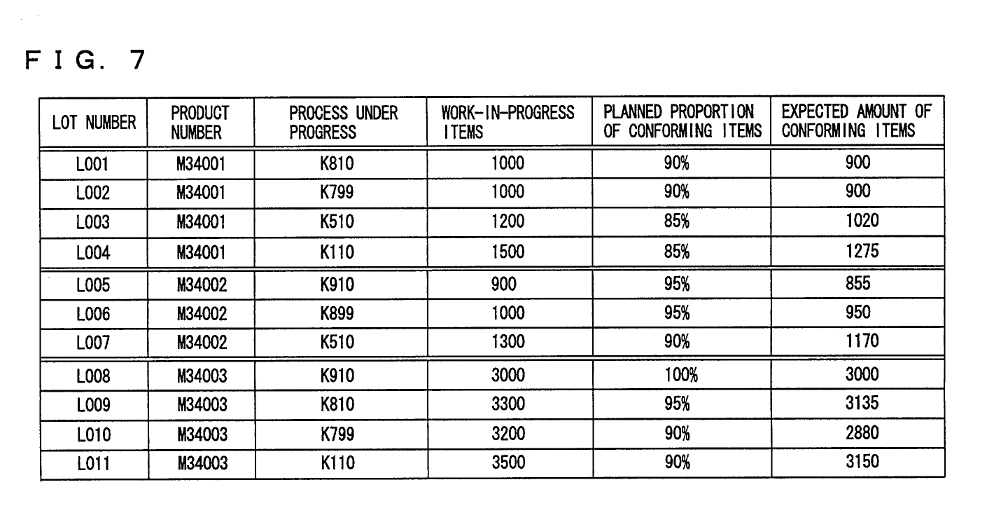

At least two lot numbers are provided for one product number (S108), and expected amount of conforming items are calculated based on the amount of work-in-progress items and planned proportion of conforming items for each lot number (S110). At this stage, expected amount of conforming item is calculated as shown in FIG. 7, which is in turn stored in the fixed disk 124.

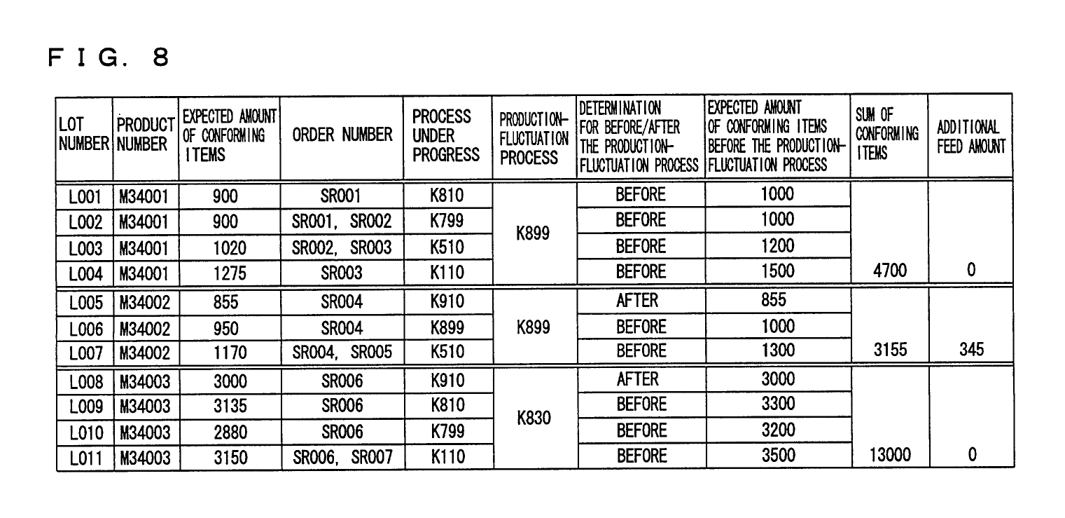

As items are fed by each lot into a process managed by the process managing computer according to the present embodiment and the production progresses at each process, the process under progress and the amount of work-in-progress items for each lot number are detected for each lot number, based on the progress management data received from the process managing computers in each process (S112). Variables L and T are initialized (L=1, T=0) (S114), and a process under progress L1 (L) of the Lth lot number and a production-fluctuation process L2 (L) of the product number corresponding to the Lth lot number are read from the fixed disk (124) (S114). If L1 (L)is a subsequent process to L2 (L) (YES at S118), which means that the lot has already completed the production-fluctuation process, then the expected amount of conforming items for the Lth lot is assigned to T (1) (S120). On the other hand, if L1 (1) is not a subsequent process to L2 (1), (NO at S118), which means the lot is in the process preceding the production-fluctuation process, then the amount of work-in-progress items for the Lth lot is assigned to T (1). Such procedure is performed in repetition for every lot belonging to one product number, and by summing either of expected amount of conforming items or the amount of work-in-progress items, sum of the amount of conforming items are calculated. The difference between the sum of the amount of conforming items and the ordered amount is determined as the additional feed amount (S130). At this stage, as shown in FIG. 8, whether each lot belonging to each product number is in the process subsequent to the production-fluctuation process or not is determined, and depending on the result, either the expected amount of conforming items or the amount of work-in-progress items is applied as an expected amount of conforming items for each lot, to derive sum of the amount of conforming items.

As described above, the process managing apparatus according to the present embodiment calculates the amount of conforming items, when work-in-progress items belonging to an identical product number are divided into a plurality of lots and fed into the production process, based on a proportion of conforming items of 100% for a lot to be subjected to the production-fluctuation process, and based on a predetermined proportion of conforming items for a lot having been subjected to the production-fluctuation process, and then by summing thus calculated amount of conforming items for every lot belonging to one product number, derives additional feed amount on a product number basis. Thus, as the extent of production fluctuation is not known for a lot before being subjected to a production-fluctuation process, the proportion of conforming items of 100% is used, so that the amount of the conforming items is calculated to be relatively large, in order to derive relatively small additional feed amount. As a result, a stable operation of production processes can be realized without incurring overproduction.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A process managing apparatus for managing a production process including a plurality of processes, said production process including at least one production-fluctuation process into which similar work-in-progress items being divided into a plurality of lots are fed, the process managing apparatus comprising:
storage means for prestoring a proportion of the amount of conforming items having been subjected to said production-fluctuation process to the feed amount of work-in-progress items into said production-fluctuation process;
detecting means for detecting feed amount for each lot in said production process;
calculating means for calculating an expected amount of conforming items, said calculating means calculating the amount of conforming items for each lot, based on said feed amount for each lot and another proportion not being identical to said proportion for a lot to be subjected to the production-fluctuation process, and based on said feed amount for each lot and said proportion for a lot having been subjected to the production-fluctuation process; and
additional feed amount calculating means for calculating amount to be fed additionally into said production process based on said calculated expected amount of conforming items.

2. The process managing apparatus according to claim 1, wherein said another proportion is higher than said proportion.

3. The process managing apparatus according to claim 1, wherein said another proportion is 100%.

4. The process managing apparatus according to claim 1 further comprising:
output means for outputting an instruction to said production process to additionally feed work-in-progress items in the amount calculated by said additional feed amount calculating means.

5. The process managing apparatus according to claim 4, wherein said another proportion is higher than said proportion.

6. The process managing apparatus according to claim 4, wherein said another proportion is 100%.
